(19) United States
(12) Patent Application Publication
(10) Pub. No.: US 2007/0175965 A1
(43) Pub. Date: Aug. 2, 2007

(54) System and method of providing endless welding wire

(75) Inventor: Michael A. Carroscia, Newbury, OH (US)

Correspondence Address: FAY SHARPE / LINCOLN, 1100 SUPERIOR AVENUE, SEVENTH FLOOR, CLEVELAND, OH, 44114, US

(73) Assignee: Lincoln Global, Inc.

(21) Appl. No.: 11/345,773

(22) Filed: Feb. 2, 2006

(51) Int. Cl. B23K 37/00; B23K 31/02

(52) U.S. Cl. 228/4.5; 228/47.1; 228/180.5

(57) ABSTRACT

A system for providing an endless welding wire to a welding station from a first and second container each having a top opening with a top, inwardly facing surface and a coil of welding wire with a feed end and a trailing, transfer end where the trailing end of the first coil is connected to the feed end of the second coil. The system comprising: a grommet with a vertical wire receiving opening floating above the containers in a given path determined by a track element slidably receiving the floating grommet and the containers each have a plurality of transfer control tabs in the top inwardly facing surface. The tabs are configured to selectively support and then release the transfer end during changeover from the wire of the first coil to the wire of the second coil to reduce the tendency for a tangle during wire changeover.

The present invention relates to the art of electric arc welding and more particularly to a system and method of providing an endless welding wire to a welding station.

### INCORPORATION BY REFERENCE

The welding wire feeding device of the present invention relates to the concept of using a continuous welding wire from successive drums containing coiled wire with a feed end and a trailing end, both of which ends are exposed from the top of the drum with the trailing end of the coil being fed to the welding station butt welded to the feed end of the next coiled welding wire. This high production technology is becoming quite popular with mass production lines such as used in automobile production. One feeder suggested for commercial application is described in PCT application WO 02/094493 where the spaced drums incorporate a wire feeder using an upper guide tube only. This application is incorporated by reference herein as background information regarding the technology to which the present invention is directed.

In accordance with the invention, a feeding grommet is moved over the drums to accommodate feeding of a coil from each of the spaced containers. The grommet of the invention is mounted to be moved in a given path by a rodless cylinder. A catalog for a rodless cylinder by Bimba Manufacturing is incorporated by reference herein as background information. The cylinder is also disclosed in Clark 5,739,704 and Yarnall 5,491,737. These patents are incorporated by reference.

An endless wire feeder is disclosed in prior application Ser. No. 10/955,729 filed Sep. 30, 2004. An endless wire container for controlling the trailing end of an endless wire package is disclosed in Ser. No. 11/140,387. These two prior pending applications by assignee are incorporated by reference herein together with the material incorporated by reference in these two applications as background disclosure but the applications themselves are not included as prior art.

### BACKGROUND OF INVENTION

For high production electric arc welding, especially in the automobile industry, there is substantial development work directed to providing endless welding wire from a continuous supply of wire by butt welding the ends of wire in coils of adjacent packages, such as drums. The use of endless welding wire reduces the down time associated with package change over in automatic and robotic welding. Endless welding wire involves welding wire coiled in two adjacent packages butt welded together so that as one coil is exhausted, the second coil automatically provides welding wire. To continue the supply of endless welding wire, an empty container is replaced by a new container having a first wire end forming the normal feed wire end and an exposed trailing end from the bottom of the new coil. The feed end is then butt welded to the exposed trailing end of the previous wire coil to continue providing welding wire. This technique is well known; however, it is seldom used because of the difficulty in feeding the wire from one coil and then the next coil by a single wire feeding device capable of accommodating wire from one drum and then wire from the next drum. The common wire feeding mechanism is a feeding grommet spaced substantially above and generally between the two containers or drums so that the wire from one drum is pulled through the vertically spaced grommet and then wire from the second drum is pulled through the same grommet. To prevent tangles and sharp bends, the vertically spaced feed grommet must be substantially above the two adjacent containers or drums. This typical feeding device for endless welding wire has two major disadvantages. First, the feed grommet is over 2 feet above the top of the adjacent containers. This creates interference with associated mechanisms and structures adjacent the wire feeder. Consequently, the two drums and the wire feeder must be spaced away from the welding station or robot so that it is in an area having a vertical clearance. In some factories, such clearance is not available, thus, causing rejection of this feeder for an endless welding wire. Furthermore, the welding wire normally at the open circuit voltage of the welding operation. Thus, the wire extending from the packages to the grommet exposes high voltage, requiring some type of protective guard around the feeding operation. Such guard presents another obstacle to using the standard feeding device for endless welding wire. In an effort to reduce the height necessary for the feeding grommet it has been proposed that the feeding grommet be mounted on a swinging arm that pivots from the center of one welding wire coil to the center of the adjacent welding wire coil, as the first coil is exhausted and the second coil replaces the first coil. This swinging arm allows the endless welding wire from the first coil to be pulled through the feeding grommet directly above the coil. As the next coil is used, the arm pivots to a position above the second coil. This mechanism reduces the height of the feeding grommet and the length of bare wire exposed during the welding operation. To assure proper orientation of the feeding grommet, the swinging arm carrying the grommet has two arcuate positions, normally locked in place by a spring biased detent. This swinging arm feeding device does reduce the height of the mechanism, but not to any great extent. The swinging action from one coil to the other coil of the endless welding wire must avoid sharp bends in the wire. Thus, the vertical height remained a spatial problem. Furthermore, the pivoting arm, not only caused certain difficulties when shifting from one coil to the next coil, but also maintained a large length of exposed, bare welding wire with open circuit voltage. The high fixed feeding grommet and swinging arm feeding grommet constitute background technology to which the present invention is directed. They both have the problem of excessive height requiring vertical clearance for the area containing the two welding wire packages and result in a substantial length of exposed wire. Furthermore, the swinging arm feeding device promotes tanglements, as the arm swung from one coil supply to the next coil supply at changeover. The present invention relates to an improved feeding device for an endless welding wire that overcomes the disadvantages associated with these prior attempts in this technical area.

In order to reduce the down time when using an endless wire system or method, there is a need to prevent a tangle when the wire from the first coil is exhausted and there is a changeover to the second coil. Jensen 2004/0155090 discloses an endless wire arrangement that attempts to overcome the tangle problem with a large bulbous device. The device is configured to interfere with the formation of a tangle by being positioned at the formation point of the tangle. This Jensen publication is also incorporated by reference herein. The structure disclosed for preventing a tangle at changeover is shaped and sized such that it falls into the inner ring by becoming lodged. The weight of the device can produce significant down force on the welding wire when the first container is exhausted. This is especially true since the device disclosed in Jensen has a central passage configuration that prevents the device from being removed from the welding wire without cutting the welding wire or destroying the device. Furthermore, systems for preventing tangle also include a plurality of devices which accumulate between adjacent containers. The various prior art arrangements for preventing tangle when there is a changeover between the coils in an endless welding wire system and method have not proven successful. The present invention is directed to solving both the problem of guiding the endless welding wire upwardly as the source of the wire changes between the first and second coils of an endless wire system or method and the prevention of a tangle when there is a wire changeover between the coils.

### THE INVENTION

The invention involves a novel system and method of providing an endless wire to a welding station from first and second containers with connected wire coils constituting an endless welding wire. The invention has the combined effect of providing an even flow of wire upwardly from the coil being used and a modification in the containers housing the coiled welding wire to prevent tangles when there is a wire changeover from the first coil to the second coil. Furthermore, the system has a protective hood to prevent debris from falling into the opened cartons that remain adjacent the welding station for long periods of time when providing an endless wire. The containers remain adjacent the welding station for the time necessary to use wire from two coils so that there is substantial time for unwanted debris, dust and other deleterious substances and items to accumulate in the container. Consequently, the novel system and method incorporates an upper protective hood over the two containers constituting the endless wire packages with necessary modifications to allow operation of the novel feeder employed in the improved combined endless wire providing mechanism.

The present invention involves a system for providing an endless welding wire to a welding station from a first and second container each having a top opening with a top inwardly facing surface and a coiled welding wire. The coil has a feed end and a trailing, transfer end. The trailing end of the first coil is welded to the feed end of the second coil and the coils each have a generally parallel, center axis extending in a given vertical direction. The system of the present invention comprises a grommet with a vertical wire receiving opening floating above the containers in a given path intersecting the axes. The path is determined by a track element slidably receiving the floating grommet. The containers each have at least one transfer control tab in the top inwardly facing surface and the tab is configured to selectively support and then release the transfer end of the wire during changeover from the wire of the first coil to the wire of the second coil. In this manner, the wire changeover is controlled by one or more tabs in the container itself that prevents tangles when there is a wire changeover from one container to the next container. Preferably, several support and release tabs are provided around the top inwardly facing surface of each container so the coil in the container has a feeding end which is pulled from the coil and the wire is then fed into the welding station. At the end of the wire of the first coil, the last loop is laid in the support tabs guiding the trailing end of the wire to the feed end of the wire in the next container. This upper disposition of the trailing or transfer end of the wire of the first coil holds the wire up and provides a direct untangled pulling action during the changeover from the wire of the first coil to the wire of the second coil. In accordance with an aspect of the invention, the system as defined above includes a hood mounted over the containers to prevent contamination by air borne debris during the long time that the containers are opened and mounted adjacent the welding station.

In accordance with another aspect of the present invention, there is provided a method of feeding a weld wire to a welding station from a first and second container of wire with each container including a top, inwardly facing surface and a coil of wire with a feed end and trailing end, where the trailing end of wire of the first coil in the first container is welded to the feed end of wire of the coil in the second container to provide an endless welding wire. The method comprises providing a wire guide grommet with an entrant end, passing the wire from the feed end to the trailing end through the grommet, moving the grommet across the containers in a given path according to the vertical orientation of the wire with respect to the entrant end of the grommet and supporting and then releasing the trailing end of the wire of the coil in the first container as the endless wire changes over from the first coil to the second coil.

Yet another aspect of the present invention is the provision of a system for providing an endless welding wire to a welding station from a first and second container each having a top opening with a top inwardly facing surface, a coil of welding wire with a feed end and a trailing, transfer end where the trailing end of the first coil is welded to the feed end of the second coil. The coils each have a generally parallel, center axis extending in a given vertical direction. The system comprises a grommet with a vertical wire receiving opening above the containers and a device to prevent wire tangles during changeover from the wire of the first coil to the wire of the second coil and a hood mounted over the containers.

The primary object of the present invention is the provision of a system and method for providing or feeding endless welding wire from two successive containers into a welding station, which system and method includes a combined improvement in the wire feeder and an arrangement to reduce the tendency to tangle when the endless wire changes over from the first coil to the second coil.

Another object of the present invention is the provision of a system and method, as defined above, which system and method supports and releases the trailing end of the wire from a first coil as it is being changed over to wire from the second coil in an endless wire installation.

Yet another object of the present invention is the provision of a system and method, as defined above, which system and method allows the use of a protective hood over the two containers forming the endless wire mechanism.

Still a further object of the present invention is the provision of a system and method, as defined above, which system and method conforms to the invention defined in the claims of this disclosure.

These and other objects and advantages will become apparent from the following description taken together with the accompanying drawings.

### BRIEF DESCRIPTION OF DRAWINGS

FIG. 1 is a pictorial view illustrating the wire feeder feature of the present invention;

FIG. 2 is a pneumatic diagram of the preferred embodiment for floating the feed grommet over the two coils of an endless wire installation with modification to accommodate use of the protective hood;

FIG. 3 is a pictorial view of the preferred embodiment of the present invention;

FIG. 4 is a pictorial view as shown in FIG. 3 with the access door removed and the front guard in the open position;

FIG. 5 is a partially cross-sectioned front view of the preferred embodiment of the present invention;

FIG. 6 is a cross-sectional view taken generally along line 6-6 of FIG. 5; and,

FIG. 7 is a top view taken generally along line 7-7 of FIG. 5.

### PREFERRED EMBODIMENT

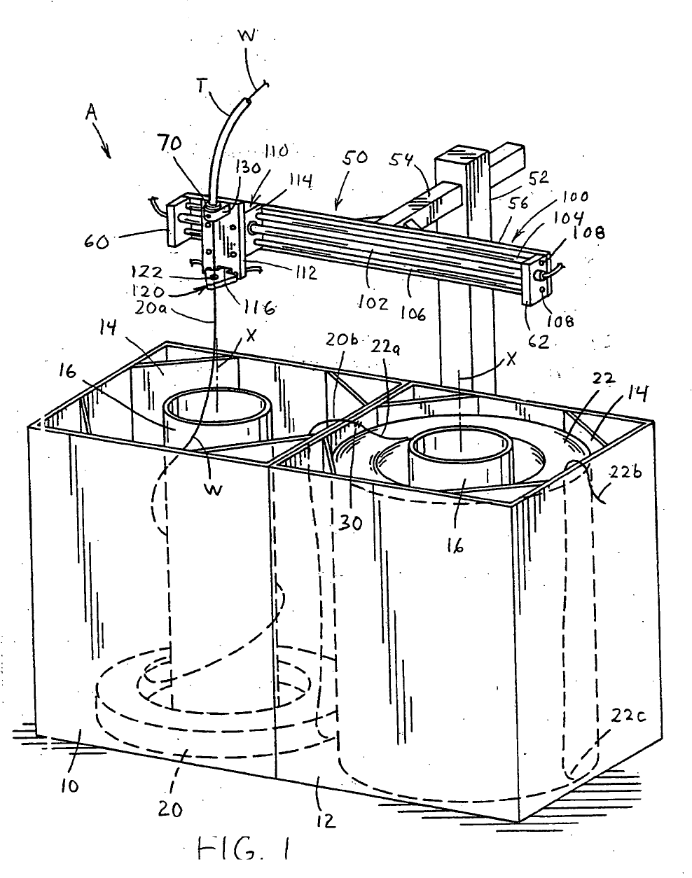

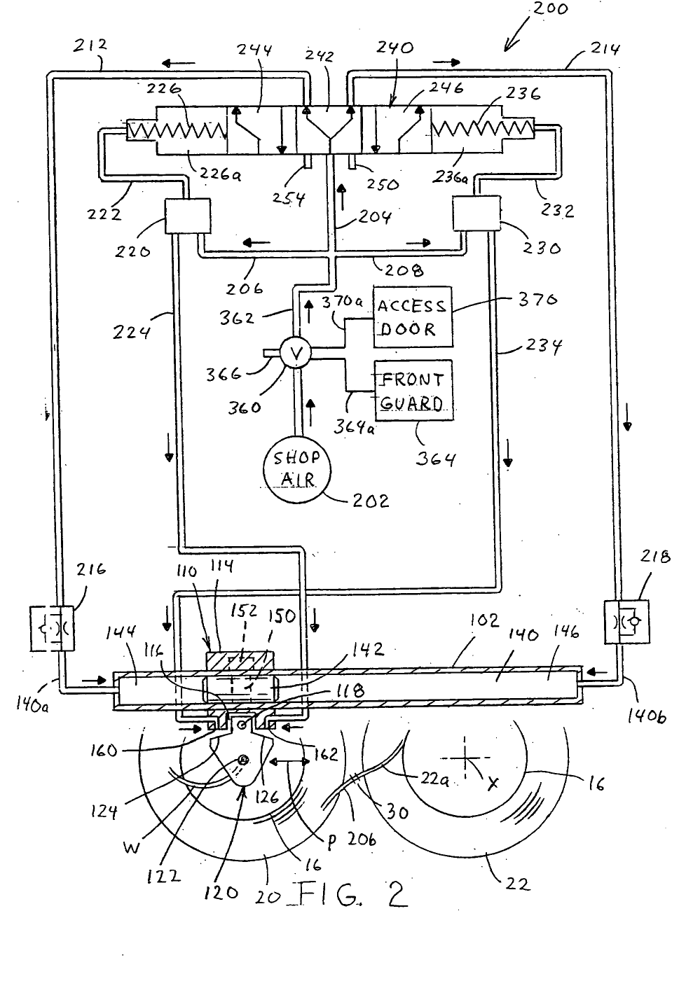

Referring now to the drawings wherein the showings are for the purpose of illustrating the preferred embodiment of the invention only and not for the purpose of limiting same, an endless wire installation A for providing wire W to a welding station through tube or sleeve T is shown in FIGS. 1 and 2. In accordance with standard technology for providing endless welding wire, a first container 10 and a second container 12 are positioned side-by-side whereby the wire W is fed from container 10 and then automatically changed over to feed wire from container 12. After the wire in container 10 is exhausted, the wire in container 12 is then pulled from the second container which is ultimately moved in the position of the first container and the vacant location of the second container is filled by a subsequent supply of coil wire. The two wires are connected by a standard butt weld for creating an endless welding wire. The term “endless” means that there are at least two containers at an installation with the trailing end of the wire in the first container connected to the feeding end of a coil of wire in the second container. In accordance with standard technology the containers could be circular drums, but are preferably cardboard boxes as shown in FIG. 1. Each container includes a peripheral liner 14 and a center, tubular core 16 having a vertical axis x. The axes of both cores are parallel. The boxes shown in FIG. 1 include a supply of welding wire in the form of coils 20, 22 having wire with feed ends 20a, 22a and trailing or transfer ends 20b, 22b, respectively. When transported, the trailing end of the coil is loose and the feed end is pulled from the coil until the trailing end at the bottom of the coil is reached. At that time, the trailing end is connected to the feed end of the next coil so there is an automatic change over from one coil to the next. To illustrate the disposition of the trailing end of the coil when the container is shipped, trailing end 22b of coil 22 is illustrated as originating from the bottom portion 22c of coil 22. Thus, when coil 22 is exhausted, the last portion of the coil pulled from the container is trailing or transfer end 22b. This is the end that is ultimately butt welded to a feed end of the next coil when the coil 20 is exhausted and replaced by a changeover to coil 22 shifted to the position of empty container 10. The present invention involves a combination of a novel feeder 50 with modifications of containers 10, 12 to control the movement of trailing ends 20a, 22a to facilitate cross-over from one coil to the other, without creating tangles and without requiring added implements or manual manipulations to facilitate tangle free crossover. Thus, endless wire installation A includes a novel feeder and a novel type of container which are combined to provide a synergistic action to improve the operation of the installation A. The feeder has a low profile that allows a protective hood which forms a further aspect of the invention.

### Floating Grommet Wire Feeder

Turning now to novel feeder 50 which is supported on stanchion 52 to provide a feed grommet 70 that floats back and forth along path P shown in FIG. 2. Since the path generally intersects vertical axes x of each coil 20, 22 grommet 70 floats back and forth to facilitate the vertical upward movement of wire W from the first coil to a second coil in a manner not requiring large head space or other physical constraints. Furthermore by using novel feeder 50 and its low profile a protective hood can be placed over open containers 10, 20 to prevent accumulation of unwanted debris and dust, even after long exposure to the environment.

The mechanical features of the practical embodiment of feeder 50 are best described in FIGS. 1 and 2. Track element 100 is mounted on support stanchion 52 having a horizontal arm 54 and a fixed back plate 56 with spaced facing ends or caps 60, 62. Track element 100 includes a center rodless cylinder 102 which is a previously described commercial product. Guide rods 104, 106 are assembled between ends 60, 62 by bolts 108 and are parallel to rodless cylinder 102. These parallel rods define the path of movement of carrier 110. Carrier 110 includes a housing with parallel guide passageways for slidably receiving in cylindrical bearings guide rods 104, 106, respectively. Front mounting plate 112 is affixed to housing 114. Housing 114 has clearance slot 116 to allow pivoting action of sensor elements 120. Upper block 130 positions guide grommet 70. Tube or guide sleeve T moves with grommet 70 to direct wire W to the welding station. A round opening in the grommet has a low friction surface, such as Teflon sleeve that surrounds its vertical axis. Sensor element 120 is pivotally mounted in clearance slot 116 by pivot pin 118. Circular opening 122 of sensor element 120 receives wire W. Sensor element 120 pivots about pin 118 as wire W is displaced to the right or to the left. Extending from element 120 are two spaced, angled cutoff surfaces 124, 126. These surfaces coact with vent orifices 160, 162 for controlling the servo mechanism 200 best shown in FIG. 2.

Carrier 110 slides on commercially available rodless cylinder 102. The details of this rod are best shown in FIG. 2. A central passage 140 slidably receives cylindrical piston 142 to define air volumes 144, 146 on opposite sides of the piston. Volume 144 is connected to air line 140a and, in a like manner, volume 146 is connected to line 140b. Within piston 142 there is a strong permanent magnet element 150 that coacts with magnets 152 in housing 114 surrounding rodless cylinder 102. Housing 114 slides on rod 102. Spaced permanent magnets in the housing face the poles of the magnet in floating piston 142. Carrier 110 is pulled axially along rods 104, 106 by movement of piston 142 caused by the difference in pressure in volumes 144, 146. Coupling of carrier 110 with piston 142 is by magnetic force between a magnet in the piston and magnets in the carrier. Thus, movement of piston 142 pulls carrier 110; however, there is no physical connection so it is possible to break the coupling with a relatively small force. In this manner, wire W can not be forced into an unnatural location or can not cause tangles by improper movement of cylinder 102. Pivoting element 120 is the sensing member for the servo mechanism 200, which member provides a signal when displacement of wire W pivots element 120 a distance covering either vent orifice 160 or vent orifice 162. Such displacement of the wire controls air in volumes 144, 146 to move carrier 110 along cylinder 102 so wire W between opening 122 and grommet 70 is generally aligned with the vertical axis of the grommet. In this manner, the grommet is moved or floats along path P to maintain a vertical orientation of wire W in gap g.

The pneumatic system 200 operates in response to the position of sensor element 120, as shown in FIG. 2. The pneumatic system can have a variety of configuration. Indeed, the servo mechanism can be mechanical or electrical. In the preferred embodiment it is pneumatic using system 200. Shop air supply 202 directs pressurized air in lines 204, 206 and 208. Lines 140a, 140b are connected to piston balancing lines 212, 214 through control valves 216, 218 allowing pressure to bleed from volumes 144, 146, but preventing rapid movement of the piston in either direction. The basic features of system 200 involves the operation of bypass valves 220, 230. Bypass 220 includes a primary outlet line 222 and pressure control line 224. Line 222 is used in conjunction with spring 226 in chamber 226a. In a like manner, bypass valve 230 includes a primary outlet line 232 and pressure control line 234. Line 232 acts in unison with spring 236 in chamber 236a. Slide valve 240 includes three sections 242, 244 and 246. Exhaust lines 250, 254 are aligned with the valve sections 242, 244 and 246 as they are moved into the center position. The position of carrier 110 is stabilized with opening 122 aligned with the vertically spaced guide grommet 70. Pressure is maintained on line 212, 216 to maintain the axial position of piston 142 and thus carrier 110 magnetically coupled to this piston. As long as the wire moves vertically through opening 122, system 200 is balanced as shown in FIG. 2. Assume that there is displacement of wire W to the right. This happens when wire W converts from coil 20 to coil 22. Element 120 pivots counterclockwise, with surface 126 closing vent orifice 162. There is a pressure buildup in line 224 so that this line can not vent bypass valve 220. Thus, the pressure in line 206 is directed to the chamber 226a of spring 226 to move slide valve 240 to the right. Thus, pressurized line 204 is connected through valve portion 244 to line 212 and line 214 is vented. Air is directed through valve 216 into volume 144 moving piston 142 to the right forcing carrier 110 to the right. This compensates for the deflection of wire W to the right. This action will continue until wire W is vertically aligned with the axis of grommet 70 by being above coil 22. When that happens, surface 126 is pivoted away from vent orifice 162 to vent the pressure in line 224. This removes pressure from line 222 causing springs 226 and 236 to center slide valve 240. Springs 226, 236 are selected to maintain valve 240 centered when vents 160, 162 are opened. When sensor element 120 pivots clockwise, the reverse action takes place. Thus, carrier 110 is moved by system 200 to maintain the upper guide grommet 70 directly above the trajectory that wire W wants to follow as it is being pulled from the containers. When the first container is exhausted and the second container is operated, element 120 is held in the position to close vent 162 until carrier 110 moves above coiled wire 22 where it is again stabilized. In this manner, the guide grommet moves or floats back and forth along path P.

### Appliances for Installation A

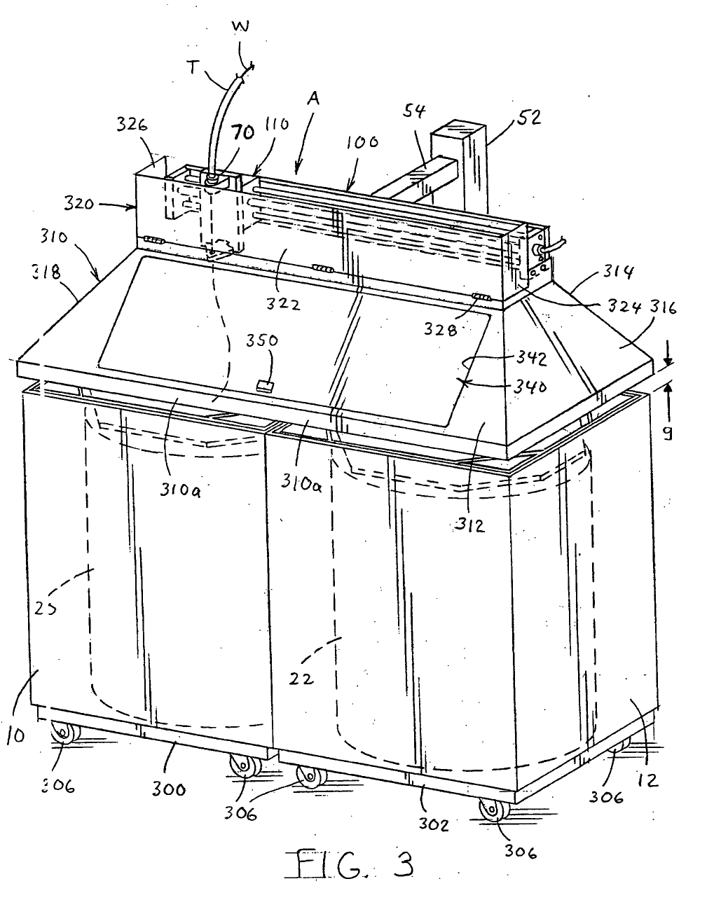

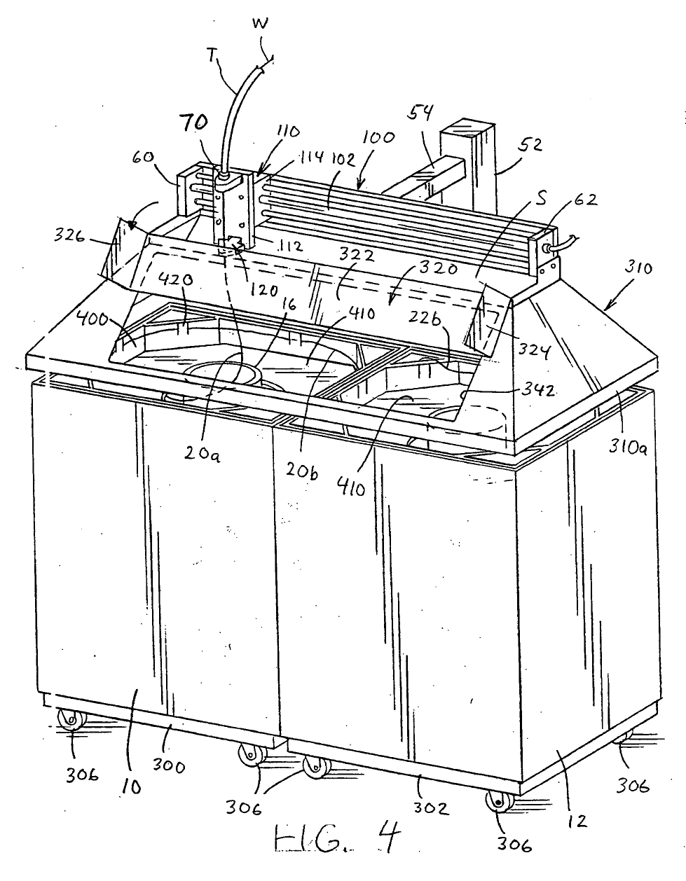

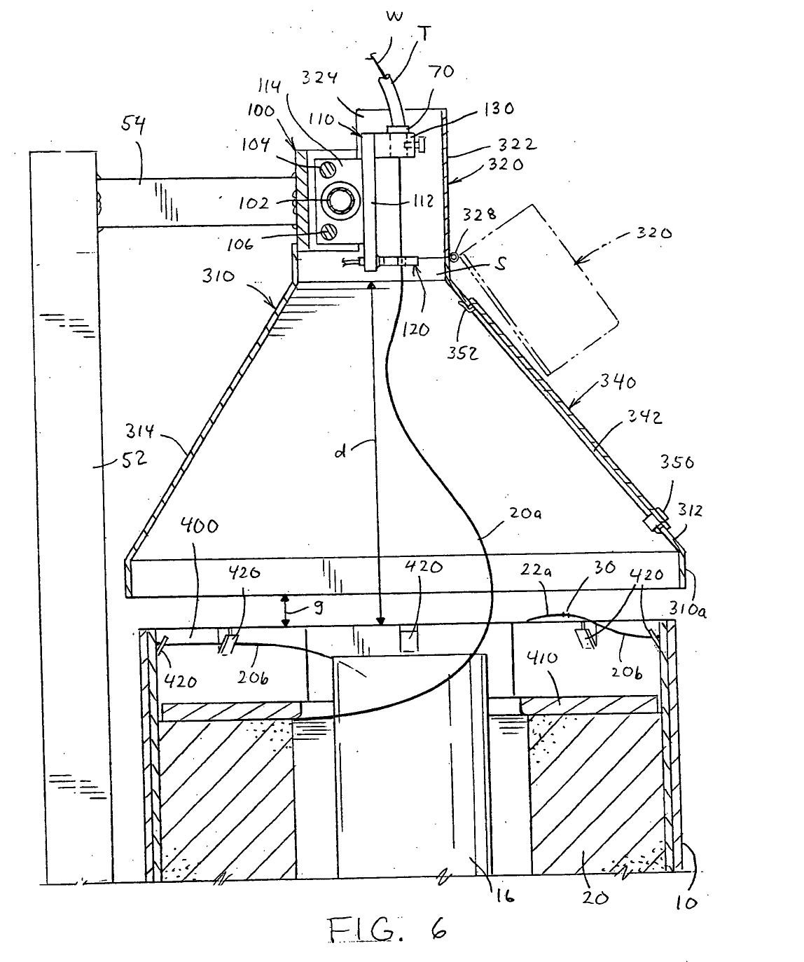

Floating grommet wire feeder 50 has a low vertical profile and does not have swinging arms and other moveable elements above containers 10, 12 since grommet 70 merely floats along track 110 between the two coils 20, 22. Thus, the low profile and the lack of obstructive mechanisms allows installation A to use a hood to protect the open containers from air borne contamination. Furthermore, the low profile of the feeding mechanism allows the wire containers to be mounted by hoist units onto dollies 300, 302. Each dolly has a flat support base 304 and four castors 306. In this manner, the containers can be easily manipulated into the position shown in FIGS. 3-5. Protective hood 310 has a truncated pyramid shape and is fixed above the top of open containers 10, 12. The hood is fixed to stanchion 52 and a has a lower peripheral rim 310a spaced from the top of the containers a distance g as best shown in FIG. 6. Pyramid shaped hood 310 includes a front angled wall 312, back angled wall 314 and angled side walls 326, 318. Rim 310a generally matches the outside profile of containers 10, 12 to prevent inadvertent contamination from above the containers. Track 100 is spaced upwardly from containers 10, 12 a distance of less than 2 feet. Hood 310 is pyramid shaped and somewhat truncated with an upper slot S providing clearance for wire W as carriage 110 slides along track 100 as best shown in FIG. 6. To provide access to the mechanism of floating grommet 70, hood 310 includes a pivoted guard panel 320 having a front wall 322 and side flaps 324, 326. Hinges 328 allow movement of guard panel 320 between the closed position shown in solid lines in FIG. 6 and the opened access position shown in phantom lines in FIG. 6. Access is obtained to track 100 and the mechanism allowing floating movement of grommet 70 by shifting guard 320 into its opened position. Hood 310 also includes an access door or cover 340 over opening 342. Latch 350 releases the bottom of cover 340 from opening 342 so the cover can be removed by disengaging catch members 352. One or more covers on front angled wall 312 allows an operator to gain access into the interior of hood 310 as needed. When panel 320 is closed, the mechanism moving grommet 70 is allowed to perform the operation as described in connection with FIG. 2. Exhaust valve 360 is positioned between the shop air supply 202 and control line 362. Sensor device 364 provides a panel closed signal in line 364a when panel 320 is closed. This opens valve 360. When there is no signal in line 364a, valve 360 is closed to exhaust line 362 to vent line 366. Access cover 340 also closes valve 360 by sensor device 370 that creates a signal in line 370a to operate valve 360 in the same manner as a signal in line 364a. Consequently, if panel 320 or cover 340 is opened system 200 is deactivated.

By the low profile and lack of obstructing mechanisms necessary for floating grommet feeder 50, the low profile hood 310 has a height d as shown in FIG. 6, which height is less than 2 feet. Such a low profile hood allows maintenance of an improved environment without requiring substantial head space. The hood is advantageous for endless wire installation A because an open container is exposed for a long period of time first awaiting its actual use and then the extended period necessary to exhaust the amount of wire which is often greater than 500 pounds.

### Tangle Resistant Mechanism

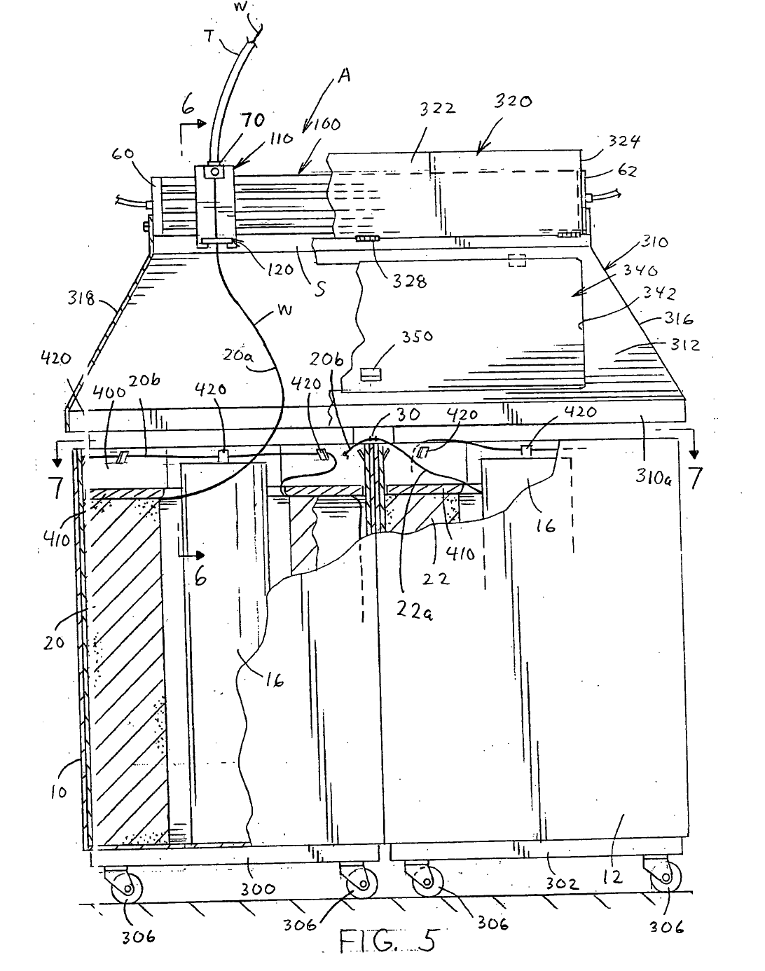

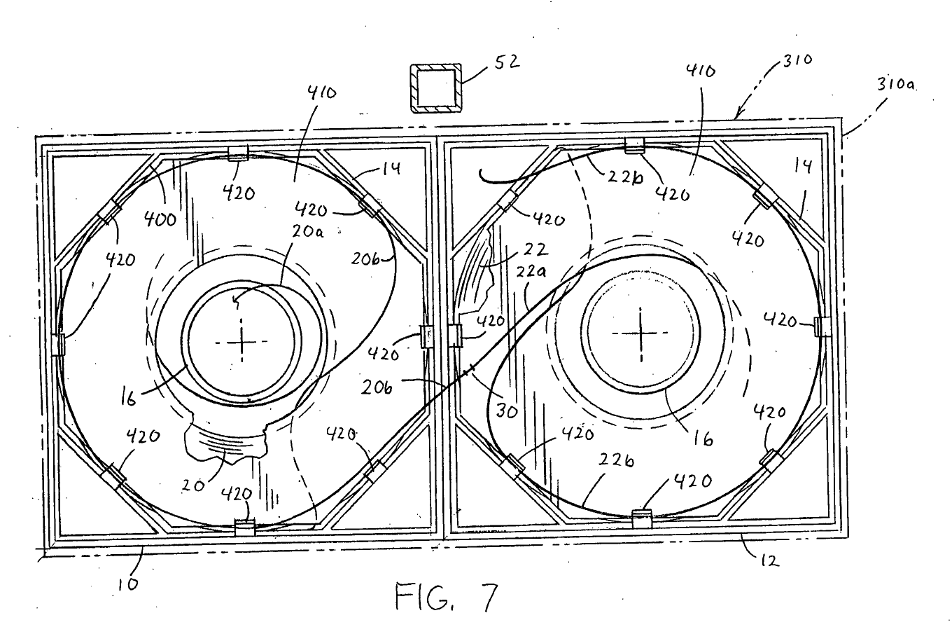

To prevent tangle between changeover from the wire on coil 20 to the wire on coil 22, the upper portion of liner 14 defines a top inwardly facing surface 400 which is above the top of the coils 20, 22 when the containers are shipped. The top surface is above payout ring 410 when the coils 20, 22 are full. A plurality of circumferentially spaced support tabs 420 are provided above ring 410 and longitudinally along top inwardly facing surface 400 of liners 14. A plurality of tabs support the trailing end of the wire and are normally in a continuous curved pattern, which pattern is preferably in a horizontal plane. These tabs are disclosed in copending application Ser. No. 11/140,387 and are preferably just merely lanced from the cardboard forming liner 14. The trailing end or transfer end of the wire in a coil of one container is laced around the upper surface 400 and held or supported in a vertical direction by tabs 420 as best shown in FIGS. 5-7. When the wire of coil 20 is exhausted, the last portion or loop of the wire is trailing end 20b held circumferentially around surface 400 by tabs 420. The final pulling action from the first coil successively removes or releases the supported trailing ends of the wire from the support tabs. Consequently, each tab supports the trailing transfer end of wire that is butt welded to the feed end of the next coil and releases the trailing end in a controlled successive manner to prevent tangles during wire cross-over. By maintaining the trailing end in a circular loop around the top of the container, there is no tendency to form an e-script tangle on the transfer or changeover from the wire of one coil to the wire of the next coil. This modification of the top portion of a container to provide a tangle resistant mechanism is a compliment to the low profile floating grommet type of wire feeder for endless wire installation A. Thus, the combination of the novel tangle resistant mechanism and the unique floating grommet type feeder provides an improved endless wire installation. These two features of the installation make it possible to provide a low profile hood that does not interfere with the operation and advantages of both features used in the preferred embodiment of the present invention.

1. A system for providing an endless welding wire to a welding station from a first and second container each having a top opening with a top, inwardly facing surface and a coil of welding wire with a feed end and a trailing, transfer end where said trailing end of said first coil is connected to the feed end of said second coil, and said coils each have a generally parallel, center axis extending in a given vertical direction, said system comprising: a grommet with a vertical wire receiving opening floating above said containers in a given path generally intersecting said axes and determined by a track element slidably receiving said floating grommet and said containers each have at least one transfer control tab in said top inwardly facing surface, said tab being configured to selectively support and then release said transfer end during changeover from said wire of said first coil to said wire of said second coil to reduce the tendency for a tangle during said changeover.

2. A system as defined in claim 1 including a support mechanism mounting said grommet on said track element for movement of the grommet above said coils and along said path.

3. A system as defined in claim 2 including a servo mechanism with an input sensor mounted on said support mechanism and spaced below an entrant end of said grommet a distance defining a gap below said grommet to sense displacement of said welding wire generally in said given direction and a motion device responsive to said sensed displacement to move said grommet in the direction of said displacement, whereby said wire is generally aligned with said wire receiving opening as the wire moves through said gap.

4. A system as defined in claim 2 wherein said track element includes at least first and second rods and said support mechanism is a carrier movable along said first rod with a guide passage for said sliding along said second rod.

5. A device as defined in claim 4 wherein said first rod is a rodless cylinder with an internal movable magnetic element and said carrier includes a magnetic coupling surrounding said first rod and movable with said magnetic element.

6. A system as defined in claim 2 wherein said motion device includes air cylinders to move said internal magnetic element.

7. A system as defined in claim 1 wherein said servo mechanism is a pneumatic servo mechanism.

8. A device as defined in claim 1 wherein said grommet is spaced above said containers a distance less than 2 feet.

9. A system as defined in claim 1 including a wire guide sleeve above said grommet for directing said weld wire toward said welding station.

10. A system as defined in claim 1 wherein said support mechanism includes a carrier for said grommet and including a pair of passageways for allowing movement of said carriage along two parallel rods extending between said locations, and a sensor spaced below said entrant end of said grommet to define a gap, said sensor creating a servo signal in response to wire being displaced from a vertical axis.

11. A system as defined in claim 1 including a plurality of said control tabs spaced around said inwardly facing surface.

12. A system as defined in claim 1 including a hood mounted over said containers, said hood having a slot extending above said path and an access door exposing said coils from the exterior of said hood.

13. A system as defined in claim 12 including a guard panel with a first closed position protecting said grommet as it floats along said path.

14. A system as defined in claim 11 wherein said tabs are in a generally horizontal plane to define a generally circular loop for said trailing end.

15. A method of feeding a welding wire to a welding station from a first and second container of wire with each container including a top, inwardly facing surface and a coil of wire with a feed end and a trailing end where the trailing end of the first container is butt welded to the feed end of said second container to provide an endless welding wire, said method comprising:
(a) providing a wire guide grommet with an entrant end;
(b) passing said wire from said feed end to said trailing end through said grommet;
(c) moving said grommet across said containers in a given path according to the vertical orientation of said wire with respect to said entrant end of said grommet; and,
(d) supporting and then releasing an upper loop of said trailing end of the wire of said first container as the endless wire changes over from said first coil to said second coil.

16. A method as defined in claim 15 including:
(e) forming said loop by a plurality of support and release taps on the upper portion of said container.

17. A method as defined in claim 15 including:
(e) providing a fixed hood over said containers with a slot above said given path.

18. A method as defined in claim 16 including:
(f) forming said loop by a plurality of support and release taps on the upper portion of said container.

19. A method as defined in claim 17 including:
(f) providing a guard panel with an open and closed position adjacent said slot; and,
(g) halting said grommet from being moved over said containers when said panel is in the closed position.

20. A system for feeding a welding wire to a welding station from a first and second container of wire with each container including a top, inwardly facing surface and a coil of wire with a feed end and a trailing end where the trailing end of the first container is connected to the feed end of said second container to provide an endless welding wire, said system comprising: a wire guide grommet with an entrant end, means for passing said wire from said feed end to said trailing end through said grommet; means for moving said grommet across said containers in a given path according to the vertical orientation of said wire with respect to said entrant end of said grommet; and, means for supporting and then releasing said trailing end of the wire of said first containers during changeover from the first coil to the second coil.

21. A system as defined in claim 20 including a fixed hood over said containers with a slot above said given path.

22. A system as defined in claim 21 wherein said hood includes a guard panel with an open and closed position adjacent said slot; and, means for halting said grommet from being moved over said containers when said panel is in the closed position.

23. A system for providing an endless welding wire to a welding station from a first and second container each having a top opening with a top, inwardly facing surface, a coil of welding wire with a feed end and a trailing, transfer end where said trailing end of said first coil is connected to the feed end of said second coil, and said coils each have a generally parallel center axis extending in a given vertical direction, said system comprising: a grommet with a vertical wire receiving opening above said containers and a device to prevent wire tangles during changeover from said wire of said first coil to said wire of said second coil and a hood mounted over said containers.

24. A system as defined in claim 23 wherein said device comprises a plurality of transfer control tabs in said top inwardly facing surface of said first container, said tabs selectively supporting and then releasing said trailing end of said first coil during changeover from said first coil to said second coil.
